(19) United States
(12) Patent Application Publication
(10) Pub. No.: US 2003/0232147 A1
(43) Pub. Date: Dec. 18, 2003

(54) Method of manufacturing a roller having a crown shape

(75) Inventors: Hiroshi Harashima, Yokohama (JP); Tomoyuki Yusa, Yokohama (JP); Kenichi Miyazaki, Yokohama (JP)

Correspondence Address: SUGHRUE MION, PLLC, 2100 PENNSYLVANIA AVENUE, N.W., WASHINGTON, DC, 20037, US

(73) Assignee: BRIDGESTONE CORPORATION

(21) Appl. No.: 10/458,191

(22) Filed: Jun. 11, 2003

(30) Foreign Application Priority Data
Jun. 12, 2002 (JP) 2002-171,615

(51) Int. Cl. B05D 1/18

(52) U.S. Cl. 427/430.1

(57) ABSTRACT

A roller having a crown shape is manufactured by pulling up a roller base having a uniform outer diameter from a paint tank at a vertical posture in such a manner that a pulling-up speed is changed in accordance with positions in an axial direction of the roller base to change a thickness of a paint coating adhered to the roller base.

### BACKGROUND OF THE INVENTION

1. Field of the Invention

This invention relates to a method of manufacturing a roller having a crown shape in section which is suitable for the manufacture of rollers such as a charging roller, a developing roller, a transfer roller, a cleaning roller, a fixing roller, a feeding roller, a carrier roller and the like used in electro-photographic devices, electrostatic recording devices and others such as copiers, printers and so on.

2. Description of Related Art

Heretofore, these rollers of this type are frequently constructed by forming a coating of one or more layers on a peripheral face of a roller base, which is made of rubber, plastic or foamed body thereof, through dip-painting of a water-soluble paint or the like for the purpose of adjusting friction characteristics or electric characteristics or protecting the peripheral face of the roller base.

In case of forming such a coating by the dip-painting on a roller base having a uniform outer diameter over its full length, it is common that as the roller base is pulled up from a paint tank at a vertical posture, a non-dried paint flows down toward a side of a lower end portion of the roller base and hence the thickness of painted coating at the side of the lower end portion is thicker than that at a side of an upper end portion. As a result, there is caused a problem that an outer diameter of a product roller including a dried coating is made larger in the lower end side than in the upper end side.

In order to solve the above problem, therefore, JP-A-8-207171 discloses the control of pulling-up speed of the roller base, and JP-A-6-282162 discloses that the outer diameter of the product roller including the dried coating is made substantially constant over its full length by gradually decreasing a diameter of the roller base itself taperingly toward its lower end.

In this type of the rollers, however, when both end portions of a central shaft attached to the roller are pushed to, for example, an optical photo-conductor drum or the like under a given pressure, deflection deformation in a direction escaping from the optical photoconductor drum or the like is caused in a central portion of the roller by a reaction force of the roller subjected to the pressure of the optical photoconductor drum or the like. There is a problem that such a deflection deformation obstructs equal contact of the roller over its full length with the optical photoconductor drum or the like.

For this end, there is a proposal that even if the deflection deformation as mentioned above is caused in the roller, the product roller has such a crown shape that an outer diameter of its central portion is maximum for equally contacting the roller with the optical photoconductor drum or the like over the full length.

In order to render the product roller into the crown shape as is expected, a method of previously rendering the roller base into a crown shape and forming a dip-painted and dried coating having approximately a constant thickness over the full length is considered in addition to the method wherein the thickness of the dip-painted and dried coating is particularly made thicker in a central portion of the roller base having approximately a uniform outer diameter over its full length. According to the former method wherein the roller base is rendered into the crown shape, however, it is usually required to apply special design or work not only to a mold for the formation of the roller base, a main body of which having substantially a cylinder shape but also to a removal of the roller base from the mold, so that it is obliged to increase the mold cost and the like.

### SUMMARY OF THE INVENTION

It is, therefore, an object of the invention to provide a method of manufacturing a roller having a crown shape in which the thickness of the coating in the central portion of the roller base can be simply made to a level as is expected without bringing about the increase of the instrument cost or the like while selecting the latter method in the dip-painting to the roller base having approximately a uniform outer diameter over its full length.

According to the invention, there is provided a method of manufacturing a roller having a crown shape by subjecting a peripheral face of a roller base to a dip-painting to make an outer diameter in a central portion of the roller base thicker than that in an end portion thereof, characterized in that when a roller base having approximately a uniform outer diameter is dipped in a paint tank over a full length while rendering a center axial line of the roller base into substantially a vertical posture and pulled up from the paint tank, a pulling-up speed is changed in accordance with positions in an axial direction of the roller base to change a thickness of a paint coating adhered to the roller base.

The term “roller base” used herein means a portion of a polymer shaped body. The roller base has or has not a central shaft.

When the roller base is pulled up from the paint tank at the vertical posture, the thickness of the non-dried coating adhered to the roller base becomes thicker as the pulling-up speed is fast or becomes thinner as the pulling-up speed is slow. The non-dried coating flows down toward a lower end side of the roller base under a fluidity condition in accordance with environment and the like up to a drying after the pulling up from the paint tank.

In the invention, therefore, the pulling-up speed of the roller base is controlled considering the flow amount of the non-dried paint while constantly maintaining a paint temperature in the paint tank, environment conditions, drying conditions and so on, whereby the non-dried coating can be formed on the peripheral face of the roller base at a desired thickness and a product roller having a crown shape as is expected can be manufactured.

It is preferable that a difference in outer diameter between the central portion and the end portion of the roller is within a range of 5-200 μm. Thus, the product roller can be pushed to the optical photoconductor drum or the like substantially equally over its full length.

When the difference in outer diameter is less than 5 μm, there are retained problems similar to the conventional rollers having a uniform outer diameter, while when it exceeds 200 μm, it is difficult to sufficiently contact the end portions of the roller to the optical photoconductor drum or the like without applying an excessive roller pushing force.

Further, it is preferable that the pulling of the roller base from the paint tank is carried out at an increasing speed in an initial pulling stage, while after approximately a half length of the roller is pulled up, the pulling-up speed is decreased.

In the initial pulling up portion, the thickness of the non-dried coating adhered gradually increases toward the lower end side, while the adhered thickness in the speed decreasing portion gradually decreases to ward the lower end side in accordance with the decreasing speed, and as a result, the thickness of the non-dried coating it self renders into substantially the crown shape.

Moreover, it is preferable that an outer profile of the coating has such a shape that a maximum part of the outer diameter is located at an upper side with respect to the central portion of the base roller. In this case, when the non-dried coating is sufficiently dried in a drying atmosphere after the roller base is completely pulled up from the paint tank, it is flown down toward the lower end side of the roller base by its own weight as a whole and hence there can be formed such an expected crown shape that the thickness of the coating after the completion of the drying is thicker just in the central portion of the roller base by about 2.5-100 μm than that in the other portions thereof.

In order to realize such a thickness difference of the coating, it is necessary that an absolute value of the coating thickness in the end portions of the roller is made large as the thickness difference becomes usually large.

According to the method of the invention, therefore, the product roller having the crown shape as is expected can be simply and cheaply manufactured only by controlling the pulling-up speed of the roller base in accordance with the positions in the axial direction of the roller base.

In the method of the invention, it is more effective to conduct the decrease of the pulling-up speed of the roller base in the last stage at plural divided steps for preventing extra flow displacement of the non-dried coating or the flowing lack thereof. For instance, when the decrease of the pulling-up speed is carried out by only one time at a position corresponding to approximately a half pulled height, if it is intended to prevent ballooning at the lower end portion of the product roller, the coating thickness at the lower end portion is too thin and the outer diameter of the product roller is apt to be thinner than that desired in the lower end portion and also the cycle time becomes undesirably long.

The decrease of the pulling-up speed at plural steps may be carried out in a secondary curve in accordance with a kind of a solvent for a paint, a viscosity of the paint and the like. When such a decrease is carried out in a primary linear curve, the crown shape as is expected can easily be formed while preventing violent change of the coating thickness between the thick portion and the thin portion of the coating thickness.

Moreover, it is preferable that the decrease of the pulling-up speed at the plural steps is carried out in such a manner that the decreasing speed in first half steps is made smaller than the decreasing speed in second half steps in order to prevent the occurrence of ballooning in the end portions of the roller while ensuring the desired coating thickness and outer diameter.

On the other hand, the increase of the pulling-up speed of the roller base in the initial stage can be carried out at plural steps. In this case, the thickness of the paint adhered can be gradually and stepwise increased in a polygonal form toward the lower end side of the roller base and hence the required coating thickness adhered can easily be realized.

In the invention, it is preferable that the increase and decrease of the pulling-up speed are carried out by an acceleration of not more than 10 mm/sec² as an absolute value. When the acceleration exceeds 10 mm/sec², the increase and decrease are violently conducted and hence it is highly feared that the thickness of the paint adhered is locally thicker or thinner.

When the pulling of the roller base from the paint tank is carried out at the increase of the pulling-up speed in the initial stage up to a given pulling-up speed and then the roller base is pulled up at the given constant pulling-up speed over approximately a half length thereof and thereafter the pulling is conducted by decreasing the pulling-up speed at two steps, a thickest zone of the paint coating adhered can be particularly enlarged at a fast and constant pulling-up speed, if necessary.

### BRIEF DESCRIPTION OF THE DRAWINGS

The invention will be described with reference to the accompanying drawings, wherein:

FIG. 1 is a schematic view illustrating a state of manufacturing a product roller with a crown shape through dip-painting;

FIG. 2 is a graph showing an embodiment of controlling a pulling-up speed of a roller base;

FIG. 3 is a graph showing another embodiment of controlling a pulling-up speed; and

FIG. 4 is a graph showing a pulling-up speed condition of a roller base in each example.

### DETAILED DESCRIPTION OF THE INVENTION

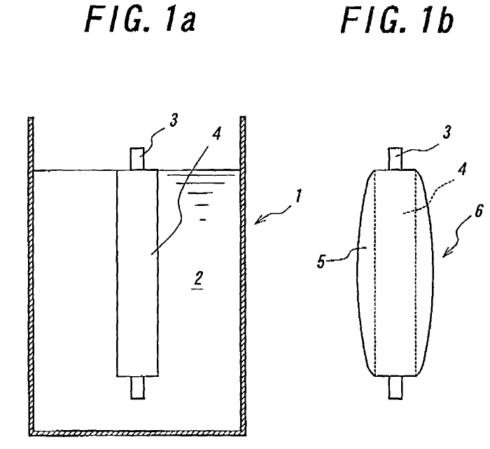

FIG. 1a shows a state that a roller base 4 provided with a central shaft 3 and having, for example, a full length of 200-400 mm is dipped in a paint tank 1 containing a paint 2 maintained at a constant temperature at a vertical posture over its full length, while FIG. 1b shows a case that a product roller 6 having a crown profile as is expected is constructed by a dried coating 5 formed on a peripheral phase of a base roller 4 pulled up from the paint tank 1 and having, for example, an outer diameter of 12 mm and a full length of 350 mm.

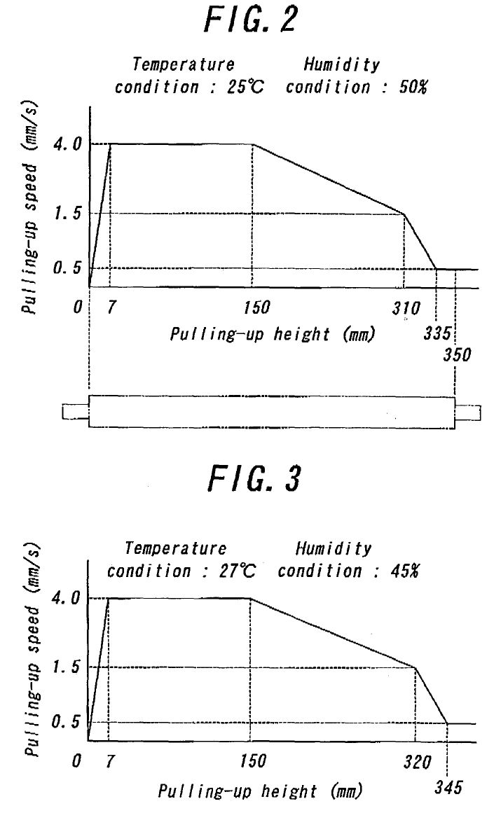

In the formation of such a dried coating 5, for example, a temperature of the paint 2 in the paint tank 1 is set to 29° C., and a temperature and a humidity around the paint tank 1 are set to 25° C. and 505, respectively, and air quantity and direction in a hot air drying furnace are controlled to constant values, respectively. At first, as a relative relation between a pulling-up height and a pulling-up speed is shown by a graph in FIG. 2 under such conditions, the pulling-up speed is linearly increased to 4.0 mm/s until the pulling-up height reaches 7 mm, and then the pulling-up speed is as constant as 4.0 mm/s until the pulling-up height reaches 150 mm, and thereafter the pulling-up speed is linearly decreased to 1.5 mm/s at a first step that the pulling-up height reaches 310 mm and subsequently the decrease of the pulling-up speed is conducted at a larger speed to 0.5 mm/s at a second step that the pulling-up height reaches 335 mm, and finally the pulling-up speed is as constant as 0.5 mm/s.

In this way, a non-dried coating having a profile similar to a rotating profile shape about a transverse axis in the speed line of FIG. 2 is formed on the peripheral face of the roller base 4.

Thereafter, the painted roller base 4 is transported into a hot air drying furnace or the like at the vertical posture, at where the non-dried coating is dried.

During the drying, the non-dried coating is flown down toward the lower end side under the environmental conditions until it is dried. After the completion of the drying, the crown profile as shown in FIG. 1b is formed as is expected.

If the drying speed of the paint is made faster by the rise of paint temperature, rise of environmental temperature, drop of environmental humidity or the like, as shown in FIG. 3, the pulling is carried out at a constant speed of 4.0 mm/s in the pulling-up height of from 7 mm to 150 mm, while the decrease of the pulling-up speed at the first step, which has been conducted at the pulling-up height of from 150 mm to 310 mm as mentioned above, is carried out over the pulling-up height range of from 150 mm to 320 mm, whereby the reduction of the flow amount of the non-dried coating is supplemented by the increase of the painted coating. This can realize the desired crown shape as shown in FIG. 1b.

Although the invention is described with respect to a case that the roller base is subjected to a single dip-painting, if the desired difference in the outer diameter can not be realized only by the single dip-painting, or if the coating having a desired thickness can not be formed, plural dip-paintings can be conducted according to the method of the invention, but also the pulling at a fast and constant pulling-up speed as shown in FIGS. 2 and 3 can be omitted in the connection with a crown shape of a desired product and further the pulling by the increase of the pulling-up speed in the initial stage on the roller base can be carried out at plural steps.

On the other hand, the pulling by the decrease of the pulling-up speed can be carried out only at one step or at three or more steps.

The following examples are given in illustration of the invention and are not intended as limitations thereof.

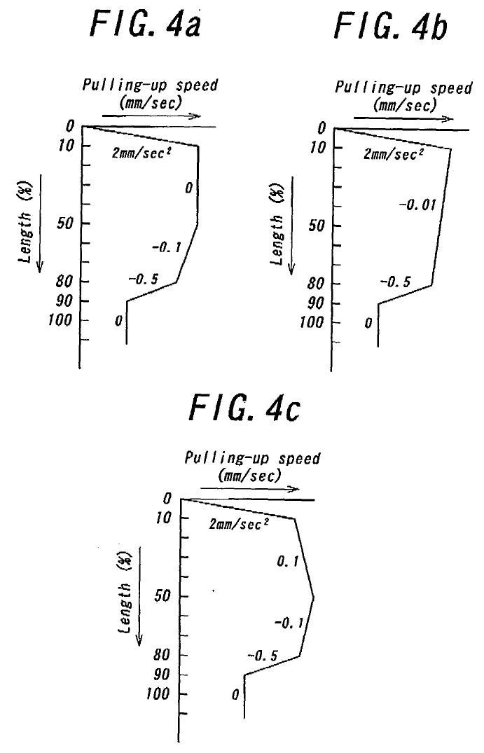

Roller bases each having an outer diameter of 12 mm and a length of 350 mm are pulled up from a paint tank according to pulling-up speed conditions as shown in Table 1 and FIG. 4, respectively. As a result, all rollers can take a crown shape in which an outer diameter in a central portion is larger than that in an end portion as is expected.

In Table 1 are also shown a difference in thickness of a dried coating between the central portion and the end portion of the roller.

TABLE 1

| Condition 1 (FIG. 4a) | | Condition 2 (FIG. 4b) | | Condition 3 (FIG. 4c) | |
|---|---|---|---|---|---|
| Position from | Acceleration | Position from | Acceleration | Position from | Acceleration |
| upper end of roller | (mm/sec²) | upper end of roller | (mm/sec²) | upper end of roller | (mm/sec²) |
| 0-10% | 2 | 0-10% | 2 | 0-10% | 2 |
| 10-50% | 0 | 10-80% | −0.01 | 10-50% | 0.1 |
| 50-80% | −0.1 | 80-90% | −0.5 | 50-80% | −0.1 |
| 80-90% | −0.5 | 90-100% | 0 | 80-90% | −0.5 |
| 90-100% | 0 | | | 90-100% | 0 |
| Difference in | 20 μm | Difference in | 10 μm | Difference in | 30 μm |
| coating thickness | | coating thickness | | coating thickness | |
| (central portion- | | (central portion- | | (central portion- | |
| end portion) | | end portion) | | end portion) | |
| Remarks | presence of constant | | absence of constant | | absence of constant |
| | pulling-up speed zone | | pulling-up speed zone | | pulling-up speed zone |

As seen from Table 1, the large difference of the coating thickness can be easily and surely realized by conducting the increase and decrease of the pulling-up speed at plural steps.

According to the invention, product rollers having a crown shape as is expected can be simply and cheaply manufactured in a high accuracy by dip-painting a roller base.

What is claimed is:

1. A method of manufacturing a roller having a crown shape by subjecting a peripheral face of a roller base to a dip-painting to make an outer diameter in a central portion of the roller base thicker than that in an end portion thereof, characterized in that when a roller base having approximately a uniform outer diameter is dipped in a paint tank over a full length while rendering a center axial line of the roller base into substantially a vertical posture and pulled up from the paint tank, a pulling-up speed is changed in accordance with positions in an axial direction of the roller base to change a thickness of a paint coating adhered to the roller base.

2. The method according to claim 1, wherein a difference in outer diameter between the central portion and the end portion of the roller is within a range of 5-200 μm.

3. The method according to claim 1, wherein said pulling of the roller base from the paint tank is carried out at an increasing speed in an initial pulling stage, while after approximately a half length of the roller is pulled up, the pulling-up speed is decreased.

4. The method according to claim 1, wherein an outer profile of the coating has such a shape that a maximum part of the outer diameter is located at an upper side with respect to the central portion of the base roller.

5. The method according to claim 4, wherein an absolute value of the coating thickness in the end portions of the roller is made large as the thickness difference becomes usually large.

6. The method according to claim 1, wherein each of the increase and the decrease of the pulling-up speed is carried out in at least one step, and the increase or decrease at each step is conducted in a primary linear curve.

7. The method according to claim 6, wherein the increase and decrease of the pulling-up speed are carried out by an acceleration of not more than 10 mm/sec² as an absolute value.

8. The method according to claim 1, wherein said pulling of the roller base from the paint tank is carried out at the increase of the pulling-up speed in the initial stage up to a given pulling-up speed and then the roller base is pulled up at the given constant pulling-up speed over approximately a half length thereof and thereafter the pulling is conducted by decreasing the pulling-up speed at two steps.
